(19) United States
(12) Patent Application Publication
(10) Pub. No.: US 2004/0077755 A1
(43) Pub. Date: Apr. 22, 2004

(54) Reduced-halogen-content flame-retardant mixtures for producing low-emission flexible polyurethane foams

(75) Inventors: Susanne Knop, Huerth (DE); Elke Huthmacher, Erftstadt (DE); Toni Nettersheim, Euskirchen (DE)

Correspondence Address: Clariant Corporation, Industrial Property Department, 4000 Monroe Road, Charlotte, NC, 28205, US

(73) Assignee: Clariant GmbH

(21) Appl. No.: 10/684,712

(22) Filed: Oct. 14, 2003

(30) Foreign Application Priority Data
Oct. 15, 2002 (DE) 10247973.9

(51) Int. Cl. C08K 5/49; C09K 21/00

(52) U.S. Cl. 524/115; 252/601

(57) ABSTRACT

The invention relates to mixtures composed of hydroxyalkyl phosphonates and chlorinated phosphoric esters, to their use, and to a process for their preparation.

The invention relates to reduced-halogen content flame-retardant mixtures, to a process for preparing these mixtures, and also to the use of this mixture as a flame retardant, in particular for producing low-emission flexible polyurethane foams.

Polyurethane foams are plastics used in many sectors, for example furniture, mattresses, transport, construction, and technical insulation applications. To comply with stringent fire-protection requirements such as those demanded for materials used, inter alia, in the interior fitting-out of automobiles, of rail vehicles, or of aircraft, or materials used to insulate buildings, polyurethane foams generally have to be provided with flame retardants. A wide variety of flame retardants are known and are commercially available for this purpose. However, their use is often inhibited by considerable technical usage problems and/or toxicological concerns.

For example, when solid flame retardants are used, e.g. melamine, ammonium polyphosphate, and ammonium sulfate, problems arise with metering techniques and often necessitate modifications to the foaming plants, i.e. complicated changes in design and modifications. Many of the liquid flame retardants used, for example tris(2-chloroethyl) phosphate, tris(2-chloroisopropyl) phosphate, and tetrakis(2-chloroethyl) ethylene diphosphate, are characterized by a marked tendency toward migration, which limits their usefulness in open-cell flexible polyurethane foam systems for the interior fitting-out of automobiles, in the light of requirements relating to condensable emissions (fogging).

Fogging is the condensation on glass panes, in particular on the windshield, of vaporized volatile constituents from the material used for interior fitting-out of the motor vehicle. A quantitative assessment of this phenomenon may be made in accordance with DIN 75201. Halogen-free flame-retardant systems are also preferred on grounds of environmental toxicology, and on grounds of improved ancillary properties in the event of a fire, in terms of smoke density and smoke toxicity. Halogen-free flame retardants can also be of particular interest for performance-related reasons. For example, when halogenated flame retardants are used severe corrosion is observed on the plant components used for the flame-lamination of polyurethane foams. This can be attributed to the hydrohalic acid emissions arising during the flame-lamination of halogen-containing polyurethane foams.

Flame-lamination is the term used for a process for bonding of textiles and foams, by using a flame to melt one side of a foam sheet, and then immediately pressing a textile web onto the same.

Because increasing attention is being paid to gaseous emissions (volatile organic compounds=VOC), there is also an increase in requirements for flame retardants which resist migration.

Examples of materials which have high resistance to migration are hydroxy-containing oligomeric phosphoric esters (DE-A 43 42 972) and hydroxyalkyl phosphonates (DE-A 199 27 548). These make only a small contribution to fogging, but the products of the latter specification have a marked plasticizing effect.

When halogen-containing flame retardants are used as in the prior art, although flame-retardant polyurethanes can be produced which give a good mechanical property profile for the foams, the use of these foams is limited by the technical processing problems of HCl liberation during flame-lamination, and the disadvantageous ancillary properties in the event of a fire. There is therefore a continuing search for systems which provide a high level of flame retardancy combined with a reduced halogen content, with no impairment of the most important properties.

It is an object of the present invention to provide flame-retardant mixtures which do not have the abovementioned disadvantages, and which give at least identical flame-retardant action at reduced halogen content.

The present object is achieved by way of mixtures composed of hydroxyalkyl phosphonates and chlorinated phosphoric esters.

Surprisingly, it has been found that the mixtures of the invention have a synergistic action, and that the amount needed in the entire mixture to achieve a comparable fire classification at reduced halogen content, and with improved fogging performance, is less than would be expected by the person skilled in the art.

These mixtures preferably comprise from 30 to 70% by weight of hydroxyalkyl phosphonate and from 70 to 30% by weight of chlorinated phosphoric esters.

These mixtures particularly preferably comprise from 40 to 60% by weight of hydroxyalkyl phosphonate and from 60 to 40% by weight of chlorinated phosphoric esters.

With preference, these mixtures comprise from 45 to 55% by weight of hydroxyalkyl phosphonates and from 55 to 45% by weight of chlorinated phosphoric esters.

The hydroxyalkyl phosphonates preferably have the formula I

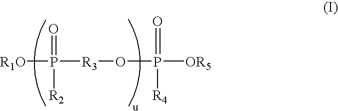

where

u denotes a chain length of from 0 to 10

R₁ and R₅ are identical or different, and are a hydroxy-containing radical of the formula II

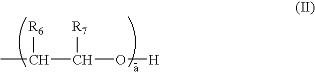

R₂ and R₄ are identical or different, and are an alkyl, aryl, or alkylaryl group having from 1 to 12 carbon atoms, and

R₃ is a radical of the formula III

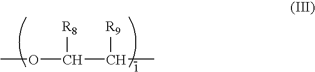

\overline{a} denotes an average chain length of from 0 to 4,

\overline{i} denotes an average chain length of from 0 to 4, and

R₆, R₇, R₈, and R₉ are identical or different and, independently of one another, are H or an alkyl group having from 1 to 6 carbon atoms.

It is particularly preferable that

u denotes a chain length of 0 or 1

\overline{a} denotes an average chain length of from 1 to 2,

\overline{i} denotes an average chain length of from 1 to 2, and

R₂ and R₄ are identical or different and, independently of one another, are an alkyl group having from 1 to 5 carbon atoms, and

R₆, R₇, R₈, and R₉ are identical or different and, independently of one another, are H or an alkyl group having 1 or 2 carbon atoms.

In the formulae of the abovementioned hydroxyalkyl phosphonates used according to the invention, numbers such as u (of formula I) indicate the frequency with which a particular group is present in the molecule. Mixtures of various hydroxyalkyl phosphonates are also possible here, and the values for u may therefore vary, the final result being an average value \overline{u}.

The hydroxyalkyl phosphonates preferably comprise oxethylated methanephosphonic acid, oxethylated ethanephosphonic acid, propoxylated methanephosphonic acid, propoxylated ethanephosphonic acid, oxethylated propanephosphonic acid, propoxylated propanephosphonic acid, diethylene glycol bis(hydroxyalkoxy) methanephosphonate, and/or ethylene glycol bis(hydroxyalkoxy) ethanephosphonate.

The halogenated phosphoric esters preferably comprise tris(2-chloroethyl) phosphate, tris(2-chloroisopropyl) phosphate, dichloro isopropyl phosphate, trisdichloroisopropyl phosphate, and/or tetrakis(2-chloroethyl) ethylenediphosphate.

The invention also provides a process for preparing flame-retardant flexible polyurethane foams with mixtures composed of hydroxyalkyl phosphonates and chlorinated phosphoric esters by reacting organic polyisocyanates with compounds having at least two hydrogen atoms reactive toward isocyanates, with conventional blowing agents, stabilizers, activators, and/or other conventional auxiliaries and additives, in the presence of halogen-free hydroxyalkyl phosphonates of the formula I and chlorinated phosphoric esters.

The mixtures composed of hydroxyalkyl phosphonates of the formula I and chlorinated phosphoric esters are preferably used in an amount of from 0.01 to 50 parts by weight, based on the resultant flexible polyurethane foam.

The mixtures composed of hydroxyalkyl phosphonates of the formula I and chlorinated phosphoric esters are preferably used in an amount of from 0.5 to 20 parts by weight, based on the resultant flexible polyurethane foam.

The mixtures composed of hydroxyalkyl phosphonates of the formula I and chlorinated phosphoric esters are preferably used in an amount of from 0.5 to 10 parts by weight, based on the resultant flexible polyurethane foam.

The hydroxyalkyl phosphonates of the formula I preferably comprise compounds which are liquid at processing temperatures. The processing temperature here is the temperature at which the polyurethane raw materials are introduced to the feed assemblies and mixing assemblies of the foaming plants. Temperatures of from 20 to 80° C. are generally selected here, depending on the viscosities of the components and the design of the feed assemblies.

The hydroxyalkyl phosphonates of the formula I preferably comprise compounds reactive toward isocyanates.

Other conventional auxiliaries may in principle be used in the abovementioned processes.

The abovementioned object is also achieved by the use of mixtures composed of hydroxyalkyl phosphonates of the formula I and chlorinated phosphoric esters as flame retardants.

The invention in particular provides the use of mixtures composed of hydroxyalkyl phosphonates of the formula I and chlorinated phosphoric esters as flame retardants for producing low-emission flame-retardant flexible polyurethane foams.

To this end, preference is given to the use of mixtures which comprise from 30 to 70% by weight of hydroxyalkyl phosphonates and from 70 to 30% by weight of chlorinated phosphoric esters.

Particular preference is given to the use of mixtures which comprise from 40 to 60% by weight of hydroxyalkyl phosphonates and from 60 to 40% by weight of chlorinated phosphoric esters.

Preference is in particular given to the use of mixtures which comprise from 45 to 55% by weight of hydroxyalkyl phosphonates and from 55 to 45% by weight of chlorinated phosphoric esters.

The production of foams based on isocyanate is known per se, and is described in DE-A 16 94 142, DE-A 16 94 215, and DE-A 17 20 768, for example.

These are mainly foams containing urethane groups and/or isocyanurate groups and/or allophanate groups and/or uretdione groups and/or urea groups and/or carbodiimide groups. The use according to the invention preferably takes place during the production of polyurethane foams and polyisocyanurate foams.

For the production of the isocyanate-based foams, use is made of the following:

Starting components: aliphatic, cycloaliphatic, araliphatic, aromatic, or heterocyclic polyisocyanates (e.g. W. Siefken in Justus Liebigs Annalen der Chemie, 562, pp. 75-136), for example those of the formula Q(NCO)ₙ, where n is from 2 to 4, preferably from 2 to 3, and Q is an aliphatic hydrocarbon radical having from 2 to 18, preferably from 6 to 10, carbon atoms, a cycloaliphatic hydrocarbon radical having from 4 to 15, preferably from 5 to 10, carbon atoms, an aromatic hydrocarbon radical having from 6 to 15, preferably from 6 to 13, carbon atoms, or an araliphatic hydrocarbon radical having from 8 to 15, preferably from 8 to 13, carbon atoms, examples being the polyisocyanates described in DE-A 28 32 253, pages 10 to 11. Particular preference is generally given to the polyisocyanates which are readily obtainable industrially and which derive from toluylene 2,4- and/or 2,6-diisocyanate or from diphenylmethane 4,4′- and/or 2,4′-diisocyanate.

Other starting components are compounds having at least two hydrogen atoms reactive toward isocyanates and having a molecular weight of from 400 to 10,000 (“polyol component”). These are not only compounds having amino groups, thio groups, or carboxy groups, but preferably compounds having hydroxy groups, in particular compounds having from 2 to 8 hydroxy groups, and specifically those of molecular weight from 1000 to 6000, preferably from 200 to 6000, generally compounds having from 2 to 8, but preferably from 2 to 6, hydroxy groups, these compounds being polyethers and polyesters, or else polycarbonates and polyesteramides, as are known per se for the production of homogeneous or cellular polyurethanes, and as are described in DE-A 28 32 253, for example. The polyesters and polyethers having at least two hydroxy groups are preferred according to the invention.

Other starting components, where appropriate, are compounds having at least two hydrogen atoms reactive toward isocyanates and having a molecular weight of from 32 to 399. In this case, too, these are compounds having hydroxy groups and/or amino groups and/or thio groups and/or carboxy groups, preferably compounds having hydroxy groups and/or amino groups, these compounds serving as chain-extenders or crosslinking agents. These compounds generally have from 2 to 8, preferably from 2 to 4, hydrogen atoms reactive toward isocyanates. Examples of these are described likewise in DE-A 28 32 253.

Water and/or highly volatile organic substances serve as blowing agents, examples being n-pentane, isopentane, cyclopentane, halogenated alkanes, such as trichloromethane, methylene chloride, or chlorofluoroalkanes, CO₂, and other substances.

Where appropriate, concomitant use is made of auxiliaries and additives, for example catalysts of the type known per se, surface-active additives, such as emulsifiers and foam stabilizers, retarders, e.g. acidic substances, such as hydrochloric acid or organic acid halides, or else cell regulators of the type known per se, for example paraffins or fatty alcohols, and dimethylpolysiloxanes, or else pigments or dyes, and other flame retardants of the type known per se, or else stabilizers to protect from the effects of aging and weather, plasticizers, and substances with fungistatic or bacteriostatic action, or else fillers, such as barium sulfate, Kieselguhr, carbon black, or precipitated chalk (DE-A 27 32 292).

Other examples of substances which are used concomitantly, where appropriate, according to the invention, these being surface-active additives and foam stabilizers, or else cell regulators, retarders, stabilizers, flame-retardant substances, plasticizers, dyes, and fillers, or else substances with fungistatic or bacteriostatic action, are described in Kunststoff-Handbuch [Plastics Handbook], Volume VII, Carl Hanser Verlag, Munich, 1993, pp. 104-123 as are details of the method of use and the mode of action of these additives.

Method for process to produce polyurethane foams:

The components for the reaction are reacted by the single-stage process known per se, the prepolymer process, or the semiprepolymer process, the machinery used frequently being, for example, that described in U.S. Pat. No. 2,764,565. Kunststoff-Handbuch [Plastics Handbook], Volume VI, Carl Hanser Verlag, Munich, 1993, pp. 139-192 describes details of other processing equipment which may be used according to the invention.

According to the invention, it is also possible to produce cold-curing foams (GB Patent 11 62 517, DE-A 21 53 086).

However, it is also possible, of course, to produce foams by slab foaming or by the twin-conveyor-belt process known per se.

Polyisocyanurate foams are produced using the processes and conditions known for that purpose.

The polyurethane plastics rendered flame-retardant according to the invention may therefore be produced in the form of elastomers by casting, or as rigid or flexible foams by a continuous or batchwise method of production, or as foamed or solid moldings.

Preference is given to flexible foams produced by a slab foaming process.

Examples of applications of the products obtainable according to the invention are: furniture padding, textile inserts, mattresses, automobile seats, armrests, and construction components, and also seat coverings and dashboard coverings.

The materials used for the examples were:

Oxethylated methanephosphonic acid (OMPA) (prepared in accordance with Houben-Weyl, Volume XII/1, Part 1, pp. 423-524)

| | |
|---|---|
| Phosphorus content: | 11.9% (w/w) |
| Acid number: | <1 mg KOH/g |
| Hydroxy number: | 385 mg KOH/g |

The chlorinated phosphoric ester also used comprised a commercially available, liquid flame retardant: tetrakis(2-chloroethyl) ethylenediphosphonate (Antiblaze V 66, Rhodia Consumer Specialities Limited)

The examples below illustrate the invention:

The flame retardants described above were incorporated into flexible polyurethane foams having an NCO index of 105, formulated as follows. The NCO index is a characteristic which describes the percentage ratio of the amount of isocyanate used to the stoichiometric amount, i.e. the calculated amount of isocyanate if each group reactive toward isocyanate reacts with one isocyanate group.

The following constituents were used for the experiments:

| | |
|---|---|
| Polyether polyol | ®Caradol SC 46-02, Shell Chemie, trifunctional |
| | polyether polyol having a hydroxy number of 48 |
| | mg KOH/g |
| Catalyst | ®Niax A-1, OSi Specialties Inc., a mixture of |
| | 70% of bis(2-dimethylaminomethyl) ether and |
| | 30% of dipropylene glycol |
| | ®Dabco 33-LV, Air Products, a mixture of |
| | 67% of dipropylene glycol and 33% of |
| | diazabicyclo[2.2.2]octane |
| Stannous | ®Desmorapid SO, Rhein Chemie Rheinau |
| ethylhexanoate | GmbH, |
| Stabilizer | ®Tegastab B3460, Th. Goldschmidt AG, |
| | polyether-modified polysiloxane |
| Toluylene diisocyanate | ®Desmodur T80/T65, Bayer AG, a mixture of |
| | Toluylene 2,4-diisocyanate and toluylene 2, |
| | 6-diisocyanate |

TABLE 1
Flexible polyurethane foam formulation

| | Envelope | Envelope |
|---|---|---|
| | density: | density: |
| Example | 25 kg/m³ | 30 kg/m³ |
| Polyether polyol (®Caradol SC 46-02) | 100 parts | 100 parts |
| Flame-retardant mixture of Examples | variable | variable |
| 1-8 (Table 2) | | |
| Water | 4.7 parts | 3.5 parts |
| bis(2-dimethylaminomethyl)ether/glycol | 0.1 part | 0.1 part |
| mixture (®Niax A1) | | |
| Diazabicyclo[2.2.2]octane/dipropylene | 0.2 part | 0.2 part |
| glycol (®Dabco 33-LV) | | |
| Silicone stabilizer (®Tegostab B 3640) | 1.3 parts | 1.3 parts |
| Stannous ethyl hexanoate | 0.10-0.20 parts | 0.10-0.20 parts |
| (®Desmorapid SO) | | |
| Toluylene diisocyanate (®Desmodur | index 105 | Index 105 |
| T80/T65) | | |

To produce the flexible polyurethane foams of the examples, all of the components—except the toluylene diisocyanate—were intimately mixed and the diisocyanate was incorporated last.

Testing of flexible polyurethane foams:

To determine the flame retardancy of the flexible polyurethane foams, the FMVSS (Federal Motor Vehicle Safety Standard) 302 test was carried out. Emission performance was determined gravimetrically by a method based on DIN 75201. The compression hardness of the foams was determined to DIN 53577 at 40% compression. The results are given in Table 2.

TABLE 2
Test results

| | | Parts per | | Fogging, | | |
|---|---|---|---|---|---|---|
| | Flame- | 100 parts of | | DIN | | Compression |
| | retardant | polyether | FMVSS 302 | 75201 | Density | hardness |
| Example | mixture | polyol | classification | [mg] | kg/m³ | [kPa] |
| 1 | 100% by | 12 | SE | 0.6 | 25 | 5.4 |
| | weight of | | | | | |
| | V66 | | | | | |
| 2 | 100% by | 8 | SE/B | 0.5 | 25 | 5.5 |
| | weight of | | | | | |
| | V66 | | | | | |
| 3 | 100% by | 8 | SE | 0.4 | 25 | 3.4 |
| | weight of | | | | | |
| | OMPS | | | | | |
| 4 | 50% by | 8 | SE | 0.4 | 25 | 5.4 |
| | weight of | | | | | |
| | V66/ | | | | | |
| | 50% by | | | | | |
| | weight of | | | | | |
| | OMPS | | | | | |
| 5 | 100% by | 8 | SE | 0.5 | 30 | 3.0 |
| | weight of | | | | | |
| | V66 | | | | | |
| 6 | 100% by | 4 | SE/B | 0.5 | 30 | 3.4 |
| | weight of | | | | | |
| | V66 | | | | | |
| 7 | 100% by | 4 | SE | 0.4 | 30 | 3.0 |
| | weight of | | | | | |
| | OMPS | | | | | |
| 8 | 50% by | 4 | SE | 0.4 | 30 | 3.6 |
| | weight of | | | | | |
| | V66/ | | | | | |
| | 50% by | | | | | |
| | weight of | | | | | |
| | OMPS | | | | | |

Terminology for assessment of fire performance:

| | |
|---|---|
| SE | self-extinguishing |
| SE/NBR | self-extinguishing/no burn rate |
| SE/B | self-extinguishing/with burn rate |
| B | burn rate |

Table 2 clearly shows that, surprisingly, at density 25 and also at density 30 the mixture of the invention permits classification in fire class SE (FMVSS 302) using amounts as small as 8 or 4 php, which would be expected only to be achievable with sole use of OMPA flame retardant, which is more effective than Antiblaze V66.

It is possible to produce flame-retardant polyurethanes with low OMPA content without giving the foams the low compression hardness expected when using hydroxy-containing phosphonic esters.

The flexible polyurethane foam of Example 4, rendered flame-retardant using the mixture of the invention, thus has half of the chlorine content of Example 1, with almost identical compression hardness and the same fire performance.

1. A mixture composed of hydroxyalkyl phosphonates and chlorinated phosphoric esters.

2. The mixture as claimed in claim 1, which comprises
from 30 to 70% by weight of hydroxyalkyl phosphonates and
from 70 to 30% by weight of chlorinated phosphoric esters.

3. The mixture as claimed in claim 1 or 2, which comprises
from 40 to 60% by weight of hydroxyalkyl phosphonates and
from 60 to 40% by weight of chlorinated phosphoric esters.

4. The mixture as claimed in one or more of claims 1 to 3, which comprises
from 45 to 55% by weight of hydroxyalkyl phosphonates and
from 55 to 45% by weight of chlorinated phosphoric esters.

5. The mixture as claimed in one or more of claims 1 to 4, wherein the hydroxyalkyl phosphonates have the formula I 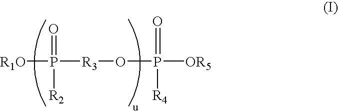
where
u denotes a chain length of from 0 to 10
R₁ and R₅ are identical or different, and are a hydroxy-containing radical of the formula II 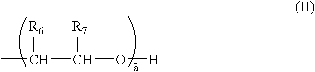
R₂ and R₄ are identical or different, and are an alkyl, aryl, or alkylaryl group having from 1 to 12 carbon atoms, and
R₃ is a radical of the formula III 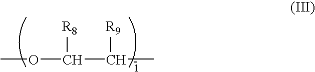
\overline{a} denotes an average chain length of from 0 to 4,
\overline{i} denotes an average chain length of from 0 to 4, and
R₆, R₇, R₈, and R₉ are identical or different and, independently of one another, are H or an alkyl group having from 1 to 6 carbon atoms.

6. The mixture as claimed in one or more of claims 1 to 5, wherein
u denotes a chain length of 0 or 1
\overline{a} denotes an average chain length of from 1 to 2,
\overline{i} denotes an average chain length of from 1 to 2, and
R₂ and R₄ are identical or different and, independently of one another, are an alkyl group having from 1 to 5 carbon atoms, and
R₆, R₇, R₈, and R₉ are identical or different and, independently of one another, are H or an alkyl group having 1 or 2 carbon atoms.

7. The mixture as claimed in one or more of claims 1 to 6, wherein the hydroxyalkyl phosphonates comprise oxethylated methanephosphonic acid, oxethylated ethanephosphonic acid, propoxylated methanephosphonic acid, propoxylated ethanephosphonic acid, oxethylated propanephosphonic acid, propoxylated propanephosphonic acid, diethylene glycol bis(hydroxyalkoxy) methanephosphonate, and/or ethylene glycol bis(hydroxyalkoxy) ethanephosphonate.

8. The mixture as claimed in one or more of claims 1 to 7, wherein the halogenated phosphoric esters comprise tris(2-chloroethyl) phosphate, tris(2-chloroisopropyl) phosphate, dichloro isopropyl phosphate, trisdichloroisopropyl phosphate, and/or tetrakis(2-chloroethyl) ethylenediphosphate.

9. A process for preparing flame-retardant flexible polyurethane foams with mixtures composed of hydroxyalkyl phosphonates and chlorinated phosphoric esters as claimed in one or more of claims 1 to 8, which comprises reacting organic polyisocyanates with compounds having at least two hydrogen atoms reactive toward isocyanates, with conventional blowing agents, stabilizers, activators, and/or other conventional auxiliaries and additives, in the presence of halogen-free hydroxyalkyl phosphonates of the formula I and chlorinated phosphoric esters.

10. A process for preparing flame-retardant flexible polyurethane foams with mixtures composed of hydroxyalkyl phosphonates and chlorinated phosphoric esters as claimed in one or more of claims 1 to 8, which comprises reacting organic polyisocyanates with compounds having at least two hydrogen atoms reactive toward isocyanates, with conventional blowing agents, stabilizers, activators, and/or other conventional auxiliaries and additives, in the presence of mixtures of halogen-free hydroxyalkyl phosphonates of the formula I and chlorinated phosphoric esters.

11. The process as claimed in claim 9 or 10, wherein mixtures composed of hydroxyalkyl phosphonates of the formula I and chlorinated phosphoric esters are used in an amount of from 0.01 to 50 parts by weight, based on the resultant flexible polyurethane foam.

12. The process as claimed in one or more of claims 9 to 11, wherein mixtures composed of hydroxyalkyl phosphonates of the formula I and chlorinated phosphoric esters are used in an amount of from 0.5 to 20 parts by weight, based on the resultant flexible polyurethane foam.

13. The process as claimed in one or more of claims 9 to 12, wherein mixtures composed of hydroxyalkyl phosphonates of the formula I and chlorinated phosphoric esters are used in an amount of from 0.5 to 10 parts by weight, based on the resultant flexible polyurethane foam.

14. The process as claimed in one or more of claims 9 to 13, wherein the hydroxyalkyl phosphonates of the formula I comprise compounds liquid at processing temperature.

15. The process as claimed in one or more of claims 9 to 14, wherein the hydroxyalkyl phosphonates of the formula I comprise compounds reactive toward isocyanates.

16. The use of mixtures composed of hydroxyalkyl phosphonates of the formula I and chlorinated phosphoric esters, as flame retardants.

17. The use of mixtures of hydroxyalkyl phosphonates of the formula I and chlorinated phosphoric esters, as flame retardants for producing low-emission flame-retardant flexible polyurethane foams.

18. The use as claimed in claim 16 or 17, wherein the materials comprise
from 30 to 70% by weight of hydroxyalkyl phosphonates and
from 70 to 30% by weight of chlorinated phosphoric esters.

19. The use as claimed in claim 16 or 17, wherein the materials comprise
from 40 to 60% by weight of hydroxyalkyl phosphonates and
from 60 to 40% by weight of chlorinated phosphoric esters.

20. The use as claimed in claim 16 or 17, wherein the materials comprise
from 45 to 55% by weight of hydroxyalkyl phosphonates and
from 55 to 45% by weight of chlorinated phosphoric esters.
